(19) United States
(12) Patent Application Publication
(10) Pub. No.: US 2025/0026687 A1
(43) Pub. Date: Jan. 23, 2025

(54) HYDRAULIC BINDER COMPOSITION

(71) Applicant: COATEX, Genay (FR)

(72) Inventors: Benoît MAGNY, Fontaines Saint Martin (FR); Michel MELAS, Montanay (FR); Laurie PARRENIN, Villeneuve (FR); Jean-Marc SUAU, Lucenay (FR); Morgane LE NEINDRE, Curis-au-Mont-d’Or (FR)

(73) Assignee: COATEX, Genay (FR)

(21) Appl. No.: 18/716,358

(22) PCT Filed: Dec. 19, 2022
(86) PCT No.: PCT/FR2022/000137

§ 371 Date: Jun. 4, 2024

(30) Foreign Application Priority Data
Dec. 20, 2021 (FR) FR2113994

(51) Int. Cl. C04B 24/26; C04B 24/16; C04B 28/02

(52) U.S. Cl. CPC C04B 24/2647; C04B 24/16; C04B 28/02

(57) ABSTRACT

A hydraulic binder composition combining a hydraulic binder compound and an alpha-sulfonated polymer A modified by reacting with a polyalkoxylated monoalcohol or with a polyalkoxylated monoamine in the presence of a sulfocarboxylic acid. A method for preparing the composition and to an agent for modifying polymer A.

The invention relates to a hydraulic binder composition combining a hydraulic binder compound and an α-sulfonated and reactively modified polymer A in the presence of a sulphocarboxylic acid, with a polyalkoxylated monoalcohol or with a polyalkoxylated monoamine. The invention also provides a method for preparing this composition as well as an agent for modifying polymer A.

There are known hydraulic binder compositions comprising a binder compound along with one or more additives, in particular an agent for controlling the rheology of the binder composition. Rheology control is an essential property of hydraulic binder compositions, in particular cement compositions or concrete or plaster compositions.

Poly(carboxylate-ether) compounds or their poly(amide-ether) analogues (PCEs) are widely used as rheology control agents in hydraulic binder compositions. Developing new PCE agents and improving their properties is therefore a very important goal.

Improving the methods for preparing hydraulic binder compositions, particularly PCE agents, is also a very common goal.

When preparing PCE agents, some compounds should be avoided or removed, in particular for efficacy and safety reasons but also for economic or environmental reasons. It can also be advantageous to be able to do without phosphorus compound when preparing PCE agents.

The reactions that make it possible to obtain PCE agents, in particular esterification or amidification reactions, must be effectively controlled. Parasitic reactions or inhibition of the reagents used must be avoided. The formation of degradation by-products or of coloured by-products, particularly as a result of excessive exposure to high temperatures, must be reduced or avoided. These ester or amide preparation compositions should have a high degree of reactivity. They should allow for high reaction kinetics. The time required to manufacture these PCE agents, and thus the binder compositions containing them, is also an important factor. It is therefore important to improve the efficacy of the various reactions involved.

Document US 20030050404 describes the preparation of poly(meth)acrylic acid in the presence of sulphur in oxidation state IV, then the modification of this polyacid with an amino-PEG in the presence of sulphuric acid.

Furthermore, it should be possible to prepare esters or amides in the absence of any compound that could be considered harmful from an environmental standpoint or in the absence of any compound that is restricted for use by regulatory provisions. In particular, preparing these compounds in the absence of any compound comprising phosphorus should be preferred, especially the absence of any phosphorus in oxidation state I, III or V. There is thus a need for hydraulic binder compositions that provide solutions to the problems of the compositions in the prior art.

The invention provides a binder composition comprising:
at least one aqueous composition R comprising at least one α-sulphonated polymer A
   i. prepared in water and in the absence of any phosphorus compound, by a polymerisation reaction of at least one monomer M chosen among acrylic acid, methacrylic acid, an acrylic acid salt, a methacrylic acid salt and combinations thereof, in the presence of at least one initiator compound and of at least one sulphur compound T comprising sulphur in oxidation state IV, then
   ii. modified, in the presence of at least one compound B chosen among a sulpho-carboxylic acid, a sulpho-carboxylic acid salt and combinations thereof, present in a molar amount greater than 2% relative to the molar amount of sulphur IV, by reaction with a compound C chosen among polyalkoxylated monoalcohols, polyalkoxylated monoamines and combinations thereof, and
at least one hydraulic binder compound L.

Preferably according to the invention, the modification of the polymer by means of compound C is carried out at a pH of less than 5, preferably at a pH of less than 4 or less than 3.5.

Also preferably according to the invention, the modification of the polymer by means of compound C is carried out at a temperature ranging from 100 to 230° C. or from 120 to 200° C.

Preferably according to the invention, compound C is a compound of formula I:

R¹-L¹-R² (I)

wherein:
R¹ independently represents a C₅-C₃₂-aromatic group, a straight or branched C₁-C₃₂-alkyl group,
R² independently represents OH or NH₂,
L¹ independently represents a group chosen among (CH₂—CH₂O)ₓ, (CH₂CH(CH₃)O)_{y}, (CH(CH₃)CH₂O)_{z} and combinations thereof and
x, y and z, identical or different, independently represent an integer or decimal comprised between 0 and 150, x is not zero and the sum of x+y+z is comprised between 10 and 150, or in which
compound C has a molecular mass ranging from 300 g/mol to 6,000 g/mol, preferably from 500 g/mol to 5,000 g/mol or from 1,000 g/mol to 3,000 g/mol.

Where appropriate, the combination of (CH₂—CH₂O)ₓ groups and of (CH₂CH(CH₃)O)_{y} or (CH(CH₃)CH₂O)_{z} groups is preferentially defined by a molar ratio [x/(y+z)] ranging from 90/10 to 40/60 or from 60/40 to 50/50, for example 80/20 or 70/30.

More preferably, compound C is a compound of formula I wherein R¹ represents a straight or branched C₁-C₁₀-alkyl group, particularly a methyl group or a propyl group. Also preferably, compound C is a compound of formula I wherein R² represents OH.

Also preferably, compound C is a compound of formula I wherein x is not zero and L¹ represents a (CH₂—CH₂O)ₓ group.

Also preferably, compound C is a compound of formula I wherein x and y or z are not zero and L¹ represents a (CH₂—CH₂O)ₓ group combined with a (CH₂CH(CH₃)O)_{y} group or a (CH(CH₃)CH₂O)_{z} group.

An equally preferred compound C is a compound of formula I wherein R¹ represents a methyl group, R² represents NH₂ and L¹ represents a (CH₂—CH₂O)ₓ group and x represents a number ranging from 10 to 150, preferably ranging from 30 to 120.

An equally preferred compound C is a compound of formula I wherein R¹ represents a methyl group, R² represents NH₂, x and y or z are not zero and L¹ represents a (CH₂—CH₂O)ₓ group combined with a (CH₂CH(CH₃)O)_{y} group or a (CH(CH₃)CH₂O)_{z} group.

Advantageously according to the invention, composition R comprises a molar amount of compound C ranging from 5% to 100%, relative to the total molar amount of monomers.

More advantageously according to the invention, composition R comprises a molar amount of compound C ranging from 10% to 100% or from 10% to 90% or from 20% to 100% or from 20% to 80%, relative to the total molar amount of monomers.

Preferably according to the invention, the modification by means of compound C is carried out at a pH of less than 5, preferably at a pH of less than 4 or less than 3.5. The pH of composition R can be lowered during the esterification and/or amidification reaction.

According to the invention, the modification by means of compound C is generally carried out at a temperature ranging from 100 to 230° C. or from 120 to 200° C.

Preferably according to the invention, the hydraulic binder compound L is a compound capable of hydrating in the presence of water to provide a solid with mechanical characteristics suitable for construction. Preferably, compound L is chosen among a cement according to 2012 standard EN 197-1, in particular a CEM I type cement, a CEM II type cement, a CEM III type cement, a CEM IV type cement, a CEM V type cement.

Preferably according to the invention, polymer A can also be modified in the presence of at least one compound chosen among a compound comprising phosphorus in oxidation state I, a compound comprising phosphorus in oxidation state III, a compound comprising phosphorus in oxidation state V and combinations thereof. Also preferably according to the invention, the polymer can be modified in the presence of at least one compound chosen among 2-sulphoacetic acid, para-toluenesulphonic acid (PTSA), sulphuric acid, their salts, and combinations thereof, in particular in the presence of at least one compound chosen among 2-sulphoacetic acid, para-toluenesulphonic acid (PTSA), their salts, and combinations thereof and in the absence of sulphuric acid.

According to the invention, composition R can also comprise at least one compound chosen among a compound comprising phosphorus in oxidation state I, a compound comprising phosphorus in oxidation state III, a compound comprising phosphorus in oxidation state V and combinations thereof. Composition R can also comprise at least one compound chosen among 2-sulphoacetic acid, para-toluenesulphonic acid (PTSA), sulphuric acid, their salts, and combinations thereof, in particular at least one compound chosen among 2-sulphoacetic acid, para-toluenesulphonic acid (PTSA), their salts, and combinations thereof and in the absence of sulphuric acid.

Preferably according to the invention, the polymerisation is carried out in the absence of any compound comprising phosphorus in oxidation state I or in the absence of any compound comprising phosphorus in oxidation state III or in the absence of any compound comprising phosphorus in oxidation state V.

Also preferably according to the invention, composition R does not comprise any compound comprising phosphorus in oxidation state I or does not comprise any compound comprising phosphorus in oxidation state III or does not comprise any compound comprising phosphorus in oxidation state V.

Essentially according to the invention, polymer A is an α-sulphonated polymer. It therefore comprises a sulphonated group in the end position. Preferably according to the invention, polymer A is chosen among an a-@-disulphonated polymer A1, an α-monosulphonated polymer A2 and combinations thereof. Polymer A1 therefore comprises a single sulphonated group at one of its end positions, while polymer A2 comprises a sulphonated group at each of its two end positions.

Preferably, the binder composition according to the invention comprises a polymer A chosen among an a-@-disulphonated polymer A1, an α-monosulphonated polymer A2 and combinations thereof.

Essentially for the invention, polymer A is prepared by means of monomer M. Preferably according to the invention, monomer M is chosen among acrylic acid, methacrylic acid and combinations thereof or a combination of acrylic acid or of an acrylic acid salt with methacrylic acid or with a methacrylic acid salt.

According to the invention, monomer M can be combined with at least one other monomer, preferably another monomer chosen among vinyl acetate, ethyl acrylate, methyl acrylate, 2-acrylamido-2-methylpropane sulphonic acid (AMPS), maleic acid, maleic anhydride, itaconic acid and combinations thereof. When combined with another monomer, monomer M can be chosen among acrylic acid, an acid salt and combinations thereof, in combination with at least one other monomer chosen among vinyl acetate, ethyl acrylate, methyl acrylate, 2-acrylamido-2-methylpropane sulphonic acid (AMPS), maleic acid, maleic anhydride, itaconic acid and combinations thereof. In combination with another monomer, the amount by weight of the other monomer is less than the amount by weight of monomer M.

Preferably according to the invention, monomer M is acrylic acid alone or in combination with methacrylic acid.

Essentially, polymer A is prepared during a polymerisation reaction of monomer M in the presence of a sulphur compound T comprising sulphur IV. Preferably, sulphur compound T is chosen among lithium hydrogen sulphite, sodium hydrogen sulphite, potassium, hydrogen sulphite, ammonium hydrogen sulphite, calcium di(hydrogen sulphite), magnesium di(hydrogen sulphite) and combinations thereof.

Preferentially according to the invention, compound T is a mono-hydrogen sulphite. The preferred sulphur compound T is sodium hydrogen sulphite, also known as sodium bisulphite.

Preferably according to the invention, the molar amount of sulphur compound T, preferably the molar amount of sulphur IV, is comprised between 1% and 15%, preferably between 1.5% and 12%, relative to the total molar amount of monomers used in the preparation of polymer A. More preferably, the molar amount of sulphur compound T, preferably the molar amount of sulphur IV, is comprised between 1% and 15%, preferably between 1.5% and 12%, relative to the total molar amount of unsaturated groups of the monomers used in the preparation of polymer A.

Preferably, the polymerisation reaction is carried out at a temperature above 30° C. and below 130° C., preferably below 100° C. or below 90° C. or below 80° C. or below 75° C. Preferably during the polymerisation reaction, the initiator compound is chosen among a peroxide (for example hydrogen peroxide), a hydroperoxide (for example tert-butyl hydroperoxide), a persulphate (for example sodium persulphate, ammonium persulphate, potassium persulphate), combinations thereof and their associations with a metal salt, preferably a metal salt chosen among an iron salt (for example Fe II or Fe III), a copper salt (for example Cu I or Cu II) and combinations thereof.

Advantageously, and in addition to sulphur compound T, polymer A can be prepared in the presence of at least one compound chosen among:
a secondary alcohol, preferably isopropyl alcohol;
another sulphur compound, preferably chosen among primary thiols, mercaptans and combinations thereof, for example tert-dodecyl mercaptan, tert-nonyl mercaptan, thiolactic acid, mercaptopropionic acid, mercaptoethanol, thioglycolic acid, 1,8-dimercapto-3,6-dioxaoctane (DMDO-CAS No. 14970-87-7);
a RAFT polymerisation agent, preferably dipropyl trithiocarbonate (DPTTC-CAS No. 6332-91-8) or salts thereof, for example its disodium salt (sodium dipropionate trithiocarbonate, CAS No. 86470-33-2), particularly in a molar amount of this agent, preferably DPTTC, comprised between 1% and 15%, relative to the total molar amount of monomers used, preferably in a molar amount, preferably DPTTC, comprised between 1.5% and 12%, relative to the total molar amount of unsaturated groups of the monomers used.

Preferably, polymer A has a weight-average molecular mass Mw (measured by SEC) less than 20,000 g/mol, preferably less than 15,000 g/mol, less than 10,000 g/mol, more preferentially less than 7,000 g/mol or less than 6,000 g/mol. Polymer A generally has a weight-average molecular mass Mw (measured by SEC) greater than 1,000 g/mol or greater than 1,200 g/mol.

Preferably, polymer A has a polymolecularity index PI (measured by SEC) of less than 4 or ranging from 1.2 to 4 or from 1.5 to 4; from 1.2 to 3 or from 1.5 to 3: from 1.2 to 2.5 or even from 1.5 to 2.5.

According to the invention, the molecular weight or mass of polymer A is determined by Size Exclusion Chromatography (SEC). A test portion of the polymer solution corresponding to 90 mg of dry solids is placed into a 10 mL flask. Mobile phase is added, together with 0.04% of dimethylformamide (DMF), until a total mass of 10 g is reached. The composition of this mobile phase is as follows: NaHCO₃: 0.05 mol/L, NaNO₃: 0.1 mol/L, triethanolamine: 0.02 mol/L, NaN₃ 0.03% by mass. The SEC chain is composed of a Waters 510 isocratic pump with a flow rate set to 0.8 mL/min, of a Waters 717+ sample changer, of an oven containing a Waters Ultrahydrogel Column Guard precolumn 6 cm long and 40 mm in inner diameter, followed by a Waters Ultrahydrogel linear column 30 cm long and 7.8 mm in inner diameter. Detection is provided by means of a Waters 410 RI differential refractometer. The oven is brought to a temperature of 60° C. and the refractometer is brought to a temperature of 45° C. The SEC instrument is calibrated with a series of polyacrylate sodium standards supplied by Polymer Standard Service with a molecular weight at the top of the peak comprised between 900 and 2,250,000 g/mol and a polymolecularity index comprised between 1.4 and 1.7. The calibration curve is straight-line and takes into account the correction obtained using the flow rate marker: dimethylformamide (DMF). Acquisition and processing of the chromatogram are performed using PSS WinGPC Scientific software v 4.02. The chromatogram obtained is incorporated into the zone corresponding to molecular weights of more than 250 g/mol.

According to the invention, polymer A can be non-neutralised or it can be partially or completely neutralised. Preferably, polymer A is non-neutralised. According to the invention, the carboxyl groups of polymer A can be partially neutralised at a rate of 70 to 97 mol %, preferably at a rate of 90 to 95 mol %.

Polymer A can be partially or completely neutralised by means of at least one monovalent ion or of at least one divalent ion. According to the invention, polymer A can be partially or completely neutralised by means of a combination of at least one monovalent ion and of at least one divalent ion. According to the invention, polymer A can then be completely or partially neutralised in variable relative molar proportions of monovalent and divalent ions. Preferably according to the invention, the monovalent ion/divalent ion molar proportions are comprised between 90/10 and 10/90 or between 80/20 and 20/80, preferably between 80/20 and 60/40, for example 70/30 or 50/50.

According to the invention, neutralisation can be carried out by means of a primary amine, of a secondary amine or of a monovalent ion chosen among K⁺, Na⁺, Li⁺, NH₄⁺ and combinations thereof. The preferred ion is NH₄⁺. According to the invention, neutralisation can also be carried out by means of a divalent ion chosen among Ca²⁺, Mg²⁺ and combinations thereof. The preferred divalent ion is Ca²⁺.

According to the invention, polymer A can be neutralised by means of at least one compound chosen among NaOH, KOH, ammonium derivatives, ammonia, primary amine, secondary amine, CaO, Ca(OH)₂, MgO, Mg(OH)₂ and combinations thereof. According to the invention, polymer A can be neutralised completely or partially by means of an amine base. Advantageously according to the invention, the amine base can also be present within composition R as an amine compound C.

Essentially, the method according to the invention uses a compound B in an acid form or in the form of a salt, preferably a sodium salt or an ammonium salt. Compound B can be added to polymer A and to compound C during the preparation of composition R. Compound B can also be derived from the polymerisation reaction of monomer M in the presence of sulphur compound T. When generated in situ, compound B is then derived from the monomer M used. Preferably according to the invention, compound B is chosen among sulpho-carboxy-aromatic acids and sulpho-carboxy-alkyl acids, preferably 3-sulphopropionic acid, 3-sulpho-2-methyl-propionic acid, sulpho-succinic acid, their salts and combinations thereof. The preferred compound B is 3-sulphopropionic acid. The preferred salts of compound B are chosen among sodium salt, potassium salt, lithium salt, calcium salt, magnesium salt and ammonium salt. The sodium salt or the ammonium salt of compound B are particularly preferred.

Preferably according to the invention, composition R comprises a molar amount of compound B greater than 5%, preferably greater than 10% or greater than 15%, more preferentially greater than 20% or greater than 25%, relative to the molar amount of sulphur IV. Also preferably according to the invention, the molar amount of compound B is less than 60%, preferably less than 50% or less than 40%, relative to the molar amount of sulphur IV.

According to the invention, compound B and the amount of compound B (mol % relative to the molar amount of sulphur IV of the compound T used) are determined by sulphate ion assay and by ¹H NMR and ¹³C NMR analysis of the sulphonated groups of polymer A and of compound B.

Preferentially according to the invention, composition R comprises a molar amount of compound C ranging from 5% to 100%, preferably from 10% to 100% or from 10% to 90% or from 20% to 100% or from 20% to 80%, relative to the total molar amount of carboxyl groups of polymer A. The molar amount of compound C can also range from 5% to 100%, preferably from 10% to 100% or from 10% to 90% or from 20% to 100% or from 20% to 80%, relative to the total molar amount of monomers.

The invention also provides a method for preparing a binder composition according to the invention comprising mixing at least one aqueous composition R according to the invention and at least one hydraulic binder compound L.

The invention also provides an agent B chosen among a sulpho-carboxylic acid, a sulpho-carboxylic acid salt and combinations thereof, for modifying an α-sulphonated polymer A prepared in water and in the absence of any phosphorus compound, by a polymerisation reaction of at least one monomer M chosen among acrylic acid, methacrylic acid, an acrylic acid salt, a methacrylic acid salt and combinations thereof, in the presence of at least one initiator compound and of at least one sulphur compound T comprising sulphur in oxidation state IV, by reaction with a compound C chosen among polyalkoxylated monoalcohols, polyalkoxylated monoamines and combinations thereof. The invention also provides a method for modifying an α-sulphonated polymer A prepared in water and in the absence of any phosphorus compound, by a polymerisation reaction of at least one monomer M chosen among acrylic acid, methacrylic acid, an acrylic acid salt, a methacrylic acid salt and combinations thereof, in the presence of at least one initiator compound and of at least one sulphur compound T comprising sulphur in oxidation state IV, by reaction with a compound C chosen among polyalkoxylated monoalcohols, polyalkoxylated monoamines and combinations thereof, in the presence of at least one compound B chosen among a sulpho-carboxylic acid, a sulpho-carboxylic acid salt and combinations thereof, present in a molar amount, measured according to the method of the description, greater than 2% relative to the molar amount of sulphur IV, comprising the maintenance or addition of at least one compound B when modifying polymer A by means of compound C.

According to the invention, the particular, advantageous or preferred characteristics of the binder composition according to the invention define methods for its preparation, methods for modifying a polymer A as well as modifying agents B which are also particular, advantageous or preferred.

The following examples illustrate the various aspects of the invention.

### EXAMPLES

### Preparation and Characterisation of Polymers A According to the Invention

### Preparation of the Base Polymer P1:

In a 1 litre glass reactor equipped with a stirrer, a thermometer and a cooling system, a load comprising 0.006 g of iron sulphate heptahydrate and 380 g of water is prepared at room temperature. Then, 3 loads to be introduced in parallel over three hours are prepared. In a first beaker 623.5 g of acrylic acid are introduced, in a second beaker 5.09 g of sodium persulphate and 46.6 g of water are introduced, and in a third beaker 122.86 g of a 40% by mass aqueous sodium bisulphite solution are introduced. After three hours of addition at 73° C., a clear dispersion of polymer PI is obtained. The concentration of dry solids is 55.2%. Polymer PI has a mass Mw of 4,430 g/mol and a PI of 2.2.

### Preparation of the Base Polymer P2:

In a 1 litre glass reactor equipped with a stirrer, a thermometer and a cooling system, a load comprising 0.023 g of iron sulphate heptahydrate and 284.13 g of water is prepared at room temperature. Then, 3 loads to be introduced in parallel over three hours are prepared. First, a load of 0.74 g of sodium persulphate and 19.68 g of water is introduced into the reactor, which has been heated to 80° C. Then, in a first beaker 450.99 g of acrylic acid are introduced, in a second beaker 1.96 g of sodium persulphate and 19.68 g of water are introduced, and in a third beaker 94.24 g of a 40% by mass aqueous sodium bisulphite solution are introduced. After three hours of addition at 80° C., a clear dispersion of polymer P2 is obtained. This polymer is then neutralised by adding sodium hydroxide to a pH of 2.0. The concentration of dry solids is 49.5%. Polymer P2 has an Mw of 6,000 g/mol and a PI of 2.7.

### Preparation of the Base Polymer P3:

In a 1 litre glass reactor equipped with a stirrer, a thermometer and a cooling system, a load comprising 0.023 g of iron sulphate heptahydrate and 284.13 g of water is prepared at room temperature. Then, 3 loads to be introduced in parallel over three hours are prepared. First, a load of 0.74 g of sodium persulphate and 19.68 g of water is introduced into the reactor, which has been heated to 80° C. Then, in a first beaker 450.99 g of acrylic acid are introduced, in a second beaker 1.96 g of sodium persulphate and 19.68 g of water are introduced, and in a third beaker 94.23 g of a 40% by mass aqueous sodium bisulphite solution are introduced. After three hours of addition at 80° C., a clear dispersion of polymer P3 is obtained. The concentration of dry solids is 48.3%. Polymer P3 has an Mw of 6,000 g/mol and a PI of 2.7.

Compound B and the amount of compound B (mol % relative to the molar amount of sulphur IV of the compound T used) comprised in each polymer dispersion P1, P2 and P3 are determined by sulphate ion assay and by ¹H NMR and ¹³C NMR analysis of the sulphonated groups of polymer P1 or P2 and of compound B.

The sulphate ion levels in polymer dispersions P1 and P2 are determined by ion chromatography. A test portion of about 80 mg of polymer dispersion is introduced into a 15 mL vial. Mobile phase is added to a total mass of 15 g. The composition of the mobile phase is as follows: sodium carbonate: 0.009 mol/L. The ion chromatography chain for the anion assay consists of a Dionex Aquion ion chromatography system with built-in degasser, of which the flow rate is set at 1 mL/min, containing a chemical suppressor, an AG9-HC precolumn, a CG3 metal trap precolumn, an NG1 precolumn and an AG9-HC column. A conductimetric detector is used for detection. The ion chromatography instrument is calibrated with a series of sodium sulphate solution standards. The calibration range is comprised between 0.5 and 100 ppm. The calibration curve is straight-line. The instrument automatically dilutes the samples to ensure that they are within the calibration range. Acquisition and processing of the chromatogram are performed using Chromeleon software 7.2.10.

¹H NMR and ¹³C NMR analyses are carried out using a Bruker AV III HD 500 spectrometer equipped with a 5 mm BBI probe. The polymer samples were dissolved in deuterated water and examined by ¹H NMR and ¹³C NMR using 2D experiments: correlations ¹H/¹³C at ordinary distance and at long distance.

The polymer dispersions P1, P2 and P3 according to the invention comprise 3-sulphopropionic acid as compound B. The results are shown in Table 1.

TABLE 1

| Polymer | P1 | P2 | P3 |
|---|---|---|---|
| Compound B (%) | 15.0 | 38.8 | 38.8 |

### Preparation of Polymer AA According to the Invention:

In a 1 litre glass reactor equipped with a stirrer, a thermometer, a cooling system and a vacuum pump, a load comprising 209.44 g of melted MPEG 2000 (methoxypolyethylene glycol with a molecular mass of 2,000 g/mol), 1.01 g of Irganox 5057, 0.65 g of NaOH at 50% by mass in water and 80 g of polymer P1 is prepared at room temperature. The reactor is heated to 100° C. and then subjected to a vacuum of 150 mbar. A temperature of 170° C. is then imposed for 5 hours. The heating is turned off. After cooling, the product is diluted to 50% in water. This results in a polymer AA with a mass Mw of 25,600 g/mol and a PI of 1.7.

### Preparation of Polymer AB According to the Invention:

In a 1 litre glass reactor equipped with a stirrer, a thermometer, a cooling system and a vacuum pump, a load comprising 209.44 g of melted MPEG 2000 (methoxypolyethylene glycol with a molecular mass of 2,000 g/mol), 1.01 g of Irganox 5057, 0.65 g of NaOH at 50% by mass in water and 89.21 g of polymer P2 is prepared at room temperature. The reactor is heated to 100° C. and then subjected to a vacuum of 150 mbar. A temperature of 170° C. is then imposed for 5 hours. The heating is turned off. After cooling, the product is diluted to 50%. This results in a polymer AB with a mass Mw of 23,500 g/mol and a PI of 1.6.

### Preparation of Polymer AC According to the Invention:

In a 1 litre glass reactor equipped with a stirrer, a thermometer, a cooling system and a vacuum pump, a load comprising 164.41 g of TSPOE25 (25-fold ethoxylated tristyrylphenol with a molecular mass of 1,570 g/mol), 1.01 g of Irganox 5057, 0.65 g of NaOH at 50% by mass in water and 80 g of polymer P1 is prepared at room temperature. The reactor is heated to 100° C. and then subjected to a vacuum of 150 mbar. A temperature of 170° C. is then imposed for 5 hours. The heating is turned off. After cooling, the product is diluted to 50%. This results in a polymer AC with a mass Mw of 23,000 g/mol and a PI of 1.7.

### Preparation of Polymer AD According to the Invention:

In a 1 litre glass reactor equipped with a stirrer, a thermometer, a cooling system and a vacuum pump, a load comprising 164.41 g of TSPOE25 (25-fold ethoxylated tristyrylphenol with a molecular mass of 1,570 g/mol), 1.01 g of Irganox 5057, 0.65 g of NaOH at 50% by mass in water and 89.21 g of polymer P2 is prepared at room temperature. The reactor is heated to 100° C. and then subjected to a vacuum of 150 mbar. A temperature of 170° C. is then imposed for 5 hours. The heating is turned off. After cooling, the product is diluted to 50%. This results in a polymer AD with a mass Mw of 21,300 g/mol and a PI of 1.6.

### Preparation of Polymer AE According to the Invention:

In a 1 litre glass reactor equipped with a stirrer, a thermometer, a cooling system and a vacuum pump, a load comprising 209.44 g of amine (33.5-fold ethoxylated ω-methyl-α-amine, propoxylated 8.4-fold, molecular mass 2,000 g/mol), 1.01 g of Irganox 5057, 0.65 g of NaOH at 50% by mass in water and 80 g of polymer P1 is prepared at room temperature. The reactor is heated to 100° C. and then subjected to a vacuum of 150 mbar. A temperature of 170° C. is then imposed for 5 hours. The heating is turned off. After cooling, the product is diluted to 50%. This results in a polymer AE with a mass Mw of 34,000 g/mol and a PI of 1.9.

### Preparation of Polymer AF According to the Invention:

In a 1 litre glass reactor equipped with a stirrer, a thermometer, a cooling system and a vacuum pump, a load comprising 209.44 g of amine (33.5-fold ethoxylated ω-methyl-α-amine, propoxylated 8.4-fold, molecular mass 2,000 g/mol), 1.01 g of Irganox 5057, 0.65 g of NaOH at 50% by mass in water and 89.21 g of polymer P2 is prepared at room temperature. The reactor is heated to 100° C. and then subjected to a vacuum of 150 mbar. A temperature of 170° C. is then imposed for 5 hours. The heating is turned off. After cooling, the product is diluted to 50%. This results in a polymer AF with a mass Mw of 33,000 g/mol and a PI of 1.9.

### Preparation of Polymer AG According to the Invention:

In a 1 litre glass reactor equipped with a stirrer, a thermometer, a cooling system and a vacuum pump, a load comprising 209.44 g of melted MPEG 2000 (methoxypolyethylene glycol with a molecular mass of 2,000 g/mol), 1.01 g of Irganox 5057, 0.65 g of NaOH at 50% by mass in water and 87.01 g of polymer P3 is prepared at room temperature. The reactor is heated to 100° C. and then subjected to a vacuum of 150 mbar. A temperature of 170° C. is then imposed for 5 hours. The heating is turned off. After cooling, the product is diluted to 50%. This results in a polymer AG with a mass Mw of 23,300 g/mol and a PI of 1.7.

### Preparation and Characterisation of Binder Compositions According to the Invention:

Mortar formulations, the compositions of which are shown in Table 2, are prepared according to the following procedure:
incorporating the admixture and the water in the bowl of an automatic Perrier mixer for standardised cements and mortars,
incorporating all the fines (cement and/or hydraulic binders),
mixing at a slow speed of 140 rpm,
incorporating the sand after 30 seconds,
mixing at a slow speed of 140 rpm for 60 seconds,
pausing for 30 seconds to clean the sides of the bowl,
mixing at a slow speed of 140 rpm for 90 seconds.

Similarly, a comparative mortar binder composition (CF) is prepared comprising no copolymer.

The water-reducing properties of the polymers according to the invention are assessed using the mortar formulations.

The T0 workability of the mortars formulated with the copolymers according to the invention was assessed by measuring the slump flow in accordance with standard EN 12350-2 adapted to mortar (Abrams mini-cone test).

To perform the slump measurement, the cone filled with formulated mortar is lifted perpendicular to a horizontal plate while rotating it one-quarter turn. The slump is measured with a ruler after 5 minutes across two 90° diameters. The result of the slump measurement is the average of the 2 values to ±1 mm.

The tests are conducted at 20° C. The admixture content is determined such that a target slump of 240 mm±5 mm can be reached. The content is expressed in % by dry weight relative to the weight of the hydraulic binder compound or of the mixture of hydraulic binder compounds. The results are shown in Table 2.

TABLE 2

| | Comparative | According to the invention | | |
|---|---|---|---|---|
| Binder composition | CF | RA | RB | RC |
| AFNOR sand (g) | 1,350 | 1,350 | 1,350 | 1,350 |
| BOSTIK CEM I | 450 | 450 | 450 | 450 |
| 42.5R cement (g) | | | | |
| Copolymer (% by | / | AA (0.17) | AB (0.17) | AG (0.17) |
| dry weight/dry | | | | |
| weight of cement) | | | | |
| Anti-foaming agent | / | 0.5 | 0.5 | 0.5 |
| (% by weight/ | | | | |
| copolymer) | | | | |
| Water (g) | 300 | 200 | 200 | 200 |
| Water/cement | 0.66 | 0.44 | 0.44 | 0.44 |
| weight ratio | | | | |
| T0 workability | 240 | 240 | 220 | 250 |
| (mm) | | | | |
| Water reduction | 0 | 33 | 33 | 33 |
| (%) | | | | |

Using the copolymers according to the invention makes it possible to reduce the amount of water in the hydraulic compositions R by 33% while maintaining an initial slump level (workability) similar to that of the comparative composition comprising no copolymer.

The copolymers according to the invention can therefore be classed as highly water-reducing agents according to standard ADJUVANT NF EN 934-2. Indeed, they make it possible to reduce the water in the admixed mortar by at least 12% relative to the reference mortar. Using the copolymers according to the invention would make it possible to obtain similar results in admixed concrete by reducing the amount of water by at least 12% relative to a reference concrete comprising no copolymer according to the invention.

1. A binder composition, comprising:
an aqueous composition R comprising an α-sulphonated polymer A prepared in water and in the absence of any phosphorus compound, by a polymerisation reaction of at least one monomer M selected from the group consisting of an acrylic acid, a methacrylic acid, an acrylic acid salt, a methacrylic acid salt, and combinations thereof, in the presence of an initiator compound and a sulphur compound T comprising sulphur in oxidation state IV, then modified, in a presence of at least one compound B selected from the group consisting of a sulpho-carboxylic acid, a sulpho-carboxylic acid salt, and combinations thereof, present in a molar amount of greater than 2% relative to a molar amount of sulphur IV, by reaction with a compound C selected from the group consisting of a polyalkoxylated monoalcohol, a polyalkoxylated monoamine, and combinations thereof; and
a hydraulic binder compound L.

2. The binder composition of claim 1, wherein:
a modification of the polymer A by compound C is carried out at a pH of less than 5 or
the modification of the polymer A by compound C is carried out at a temperature of 100 to 230° C.,
wherein compound C is a compound of formula I:
R¹-L¹-R² (I)
wherein
R¹ independently represents a C₅-C₃₂-aromatic group, a straight or branched C₁-C₃₂-alkyl group,
R² independently represents OH or NH₂,
L¹ independently represents a group selected from the group consisting of (CH₂—CH₂O)ₓ, (CH₂CH(CH₃)O)_{y}, (CH(CH₃)CH₂O)_{z}, and combinations thereof and
x, y, and z, identical or different, independently represent an integer or decimal comprised between 0 and 150, x is not zero and the sum of x+y+z is comprised between 10 and 150, or
wherein compound C has a molecular mass of 300 g/mol to 6,000 g/mol.

3. The binder composition of claim 1, wherein the binder compound L is a compound capable of hydrating in the presence of water to provide a solid with mechanical characteristics suitable for construction.

4. The binder composition of claim 1, wherein
the polymer A is modified in the presence of at least one compound selected from the group consisting of a compound comprising phosphorus in oxidation state I, a compound comprising phosphorus in oxidation state III, a compound comprising phosphorus in oxidation state V, and combinations thereof, or
the polymer A is modified in the presence of at least one compound selected from the group consisting of a 2-sulphoacetic acid, a para-toluenesulphonic acid (PTSA), a sulphuric acid, salts thereof, and combinations thereof, or
wherein the aqueous composition R further comprises at least one compound selected from the group consisting of a compound comprising phosphorus in oxidation state I, a compound comprising phosphorus in oxidation state III, a compound comprising phosphorus in oxidation state V, and combinations thereof, or
wherein the aqueous composition R further comprises at least one compound selected from the group consisting of a 2-sulphoacetic acid, a para-toluenesulphonic acid (PTSA), a sulphuric acid, their salts thereof, and combinations thereof.

5. The binder composition of claim 1,
wherein the polymerisation reaction is carried out in the absence of at least one compound selected from the group consisting of a compound comprising phosphorus in oxidation state I, or in the absence of any compound comprising phosphorus in oxidation state III, or in the absence of any compound comprising phosphorus in oxidation state V, or
in which wherein the aqueous composition R does not comprise at least one compound selected from the group consisting of a compound comprising phosphorus in oxidation state I, or does not comprise any compound comprising phosphorus in oxidation state III, or does not comprise any compound comprising phosphorus in oxidation state V.

6. The binder composition of claim 1, wherein
the polymer A is selected from the group consisting of an α-ω-disulphonated polymer A1, an α-monosulphonated polymer A2, and combinations thereof, or
the polymer A has a weight-average molecular mass (Mw) less than 20,000 g/mol, or
the polymer A has a weight-average molecular mass (Mw) greater than 1,000 g/mol, or
the polymer A has a polymolecularity index (PI) of less than 4.

7. The binder composition of claim 1, wherein:
the monomer M is selected from the group consisting of an acrylic acid, a methacrylic acid, and combinations thereof, or a combination of acrylic acid or of an acrylic acid salt with methacrylic acid, or with a methacrylic acid salt, or
the monomer M is combined with at least one other monomer selected from the group consisting of a vinyl acetate, an ethyl acrylate, a methyl acrylate, a 2-acrylamido-2-methylpropane sulphonic acid (AMPS), a maleic acid, a maleic anhydride, an itaconic acid, and combinations thereof, or
the monomer M is selected from the group consisting of an acrylic acid, an acid salt, and combinations thereof, combined with at least one other monomer selected from the group consisting of a vinyl acetate, an ethyl acrylate, a methyl acrylate, a 2-acrylamido-2-methylpropane sulphonic acid (AMPS), a maleic acid, a maleic anhydride, an itaconic acid, and combinations thereof, or
the monomer M is an acrylic acid alone or in combination with a methacrylic acid
the sulphur compound T is selected from the group consisting of a lithium hydrogen sulphite, a sodium hydrogen sulphite, a potassium hydrogen sulphite, an ammonium hydrogen sulphite, a calcium di(hydrogen sulphite), a magnesium di(hydrogen sulphite), and combinations thereof, or
the polymerisation reaction is carried out at a temperature above 30° C. and below 130° C., or wherein
the polymer A is prepared in the presence of at least one initiator compound, or
the polymer A is non-neutralised or the polymer A is partially or completely neutralised.

8. The binder composition of claim 1, further comprising
a molar amount of sulphur compound T between 1% and 15 relative to a total molar amount of monomers in a preparation of polymer A,
a molar amount of sulphur compound T between 1% and 15% relative to a total molar amount of unsaturated groups in the monomers in a preparation of polymer A.

9. The binder composition of claim 1, wherein
the compound B is selected from the group consisting of a sulpho-carboxy-aromatic acid and a sulpho-carboxy-alkyl acid, or a salt of compound B selected from the group consisting of a sodium salt, a potassium salt, a lithium salt, a calcium salt, a magnesium salt, and an ammonium salt.

10. The binder composition of claim 1, wherein the aqueous composition R further comprises:
a molar amount of compound B greater than 5% relative to the molar amount of sulphur IV, or
a molar amount of compound B less than 60% relative to the molar amount of sulphur IV.

11. The binder composition of claim 1, wherein the aqueous composition R further comprises:
a molar amount of compound C of 5% to 100% relative to a total molar amount of carboxyl groups of polymer A, or
a molar amount of compound C of 5% to 100% relative to a total molar amount of monomers.

12. A method for preparing the binder composition of claim 1, comprising:
mixing the aqueous composition R and the hydraulic binder compound L.

13. An agent B selected from the group consisting of a sulpho-carboxylic acid, a sulpho-carboxylic acid salt, and combinations thereof, for modifying an α-sulphonated polymer A prepared in water and in the absence of any phosphorus compound, by a polymerisation reaction of at least one monomer M selected from the group consisting of an acrylic acid, a methacrylic acid, an acrylic acid salt, a methacrylic acid salt, and combinations thereof, in the presence of a initiator compound and a sulphur compound T comprising a sulphur in oxidation state IV, by reaction with a compound C selected from the group consisting of a polyalkoxylated monoalcohol, a polyalkoxylated monoamine, and combinations thereof.

14. A method for modifying an α-sulphonated polymer A prepared in water and in the absence of a phosphorus compound, by a polymerisation reaction of a monomer M selected from the group consisting of an acrylic acid, a methacrylic acid, an acrylic acid salt, a methacrylic acid salt, and combinations thereof, in the presence of a initiator compound and of a sulphur compound T comprising a sulphur in oxidation state IV, by reaction with a compound C selected from the group consisting of a polyalkoxylated monoalcohol, a polyalkoxylated monoamine, and combinations thereof, in the presence of at least one compound B selected from the group consisting of a sulpho-carboxylic acid, a sulpho-carboxylic acid salt, and combinations thereof, present in a molar amount of greater than 2% relative to a molar amount of sulphur IV, comprising:
maintaining or adding a compound B when modifying polymer A with compound C.
